(19) United States
(12) Patent Application Publication
(10) Pub. No.: US 2022/0389201 A1
(43) Pub. Date: Dec. 8, 2022

(54) ACRYLIC RUBBER COMPOSITION AND CROSSLINKED PRODUCT THEREOF

(71) Applicant: Denka Company Limited, Tokyo (JP)

(72) Inventors: Tatsuya NAKANO, Tokyo (JP); Yuya KAMBE, Tokyo (JP); Toshiaki MIYAUCHI, Tokyo (JP)

(73) Assignee: Denka Company Limited, Tokyo (JP)

(21) Appl. No.: 17/829,494

(22) Filed: Jun. 1, 2022

(30) Foreign Application Priority Data
Jun. 3, 2021 (JP) 2021-093464

(51) Int. Cl. C08L 13/00

(52) U.S. Cl. CPC C08L 13/00

(57) ABSTRACT

An acrylic rubber composition containing: an acrylic rubber containing 100 parts by mass of an alkyl acrylate and 30 to 60 parts by mass of an alkyl methacrylate, as monomer units; a carbon black; a crosslinking agent; and a crosslinking accelerator.

### TECHNICAL FIELD

The present invention relates to an acrylic rubber composition, and a crosslinked product thereof.

### BACKGROUND

Acrylic rubbers or crosslinked products thereof have been often used as materials for hose members, sealing members, and the like in an automobile engine compartment requiring heat resistance. As a means for improving the heat resistance of the acrylic rubber, a technique in which a specific carbon black is contained in an acrylic rubber composition (see, for example, International Publication WO 2008/143300) and a technique in which specific anti-aging agents are contained in combination in an acrylic rubber composition (see, for example, Japanese Unexamined Patent Publication No. 2011-032390) have been known.

### SUMMARY

However, the acrylic rubbers are also required to have even more improved heat resistance to meet recent demands including gas emission controls, higher engine output, and the like. In addition, since the acrylic rubber may be used in an acidic or alkaline environment depending on the application, it is desirable that the acrylic rubber has excellent chemical resistance to such an environment (acid resistance and alkali resistance).

In view of such circumstances, an object of one aspect of the present invention is to obtain a crosslinked product of an acrylic rubber composition which has excellent heat resistance and chemical resistance.

In some aspects, the present invention includes the following embodiments.

(1) An acrylic rubber composition containing: an acrylic rubber containing 100 parts by mass of an alkyl acrylate and 30 to 60 parts by mass of an alkyl methacrylate, as monomer units; a carbon black; a crosslinking agent; and a crosslinking accelerator.

(2) The acrylic rubber composition according to (1), wherein the alkyl methacrylate is n-butyl methacrylate.

(3) The acrylic rubber composition according to (1) or (2), wherein the alkyl acrylate is one or more selected from the group consisting of ethyl acrylate and n-butyl acrylate.

(4) The acrylic rubber composition according to any one of (1) to (3), wherein the acrylic rubber further contains a crosslinking monomer having a carboxy group as a monomer unit.

(5) The acrylic rubber composition according to any one of (1) to (4), wherein the acrylic rubber further contains ethylene as a monomer unit.

(6) The acrylic rubber composition according to any one of (1) to (5), wherein the crosslinking agent is a diamine-based crosslinking agent, and the crosslinking accelerator is one or more selected from the group consisting of an amine-based crosslinking accelerator and a guanidine-based crosslinking accelerator.

(7) A crosslinked product of the acrylic rubber composition according to any one of (1) to (6).

(8) A hose member containing the crosslinked product according to (7).

(9) A seal member containing the crosslinked product according to (7).

(10) A vibration-proof rubber member containing the crosslinked product according to (7).

According to one aspect of the present invention, a crosslinked product of an acrylic rubber composition which has excellent heat resistance and chemical resistance can be obtained.

### DETAILED DESCRIPTION

Hereinafter, embodiments of the present invention will be described in detail, however, the present invention is not limited to each embodiment described below. In the present specification, “A to B” in the numerical range means a range of A or more and B or less.

(Acrylic Rubber)

An acrylic rubber of the present embodiment contains 100 parts by mass of an alkyl acrylate and 30 to 60 parts by mass of an alkyl methacrylate, as monomer units. The alkyl acrylate becomes the skeleton of the acrylic rubber, and heat resistance and chemical resistance of the acrylic rubber and a crosslinked product thereof can be adjusted by adjusting the content of the alkyl methacrylate to the alkyl acrylate which are contained as the monomer units.

The alkyl acrylate is not particularly limited, but examples thereof include alkyl acrylates having an alkyl group with 1 to 16 carbon atoms, and specific examples thereof include methyl acrylate, ethyl acrylate, n-propyl acrylate, isopropyl acrylate, n-butyl acrylate, isobutyl acrylate, n-pentyl acrylate, isoamyl acrylate, n-hexyl acrylate, 2-methyl pentyl acrylate, n-octyl acrylate, 2-ethylhexyl acrylate, lauryl acrylate, hexadecyl acrylate, 1-adamantyl acrylate, and cyclohexyl acrylate. These alkyl acrylates may be used singly or in combination of two or more. From the viewpoint of further improving the heat resistance of the acrylic rubber composition and the crosslinked product thereof and also further improving chemical resistance, the alkyl acrylate is preferably alkyl acrylate having an alkyl group with 2 to 4 carbon atoms and more preferably one or more selected from the group consisting of ethyl acrylate and n-butyl acrylate.

The content of the monomer unit of the alkyl acrylate in the acrylic rubber (hereinafter, also referred to as the alkyl acrylate unit) is preferably 40% by mass or more, more preferably 45% by mass or more, and further preferably 50% by mass or more, with respect to the whole monomer units (100% by mass) constituting the acrylic rubber. The content of the alkyl acrylate unit is preferably 99% by mass or less, more preferably 95% by mass or less, and further preferably 90% by mass or less, with respect to the whole monomer units (100% by mass) constituting the acrylic rubber. The content of the alkyl acrylate unit is quantitatively determined on the basis of a nuclear magnetic resonance spectrum obtained from the acrylic rubber or the acrylic rubber composition.

The acrylic rubber further contains an alkyl methacrylate as the monomer units. The alkyl methacrylate is not particularly limited, but examples thereof include alkyl methacrylates having an alkyl group with 1 to 4 carbon atoms, and specific examples thereof include methyl methacrylate, ethyl methacrylate, n-propyl methacrylate, isopropyl methacrylate, n-butyl methacrylate, and isobutyl methacrylate. These alkyl methacrylates may be used singly or in combination of two or more. From the viewpoint of further improving the heat resistance of the acrylic rubber composition and the crosslinked product thereof, the alkyl methacrylate is preferably n-butyl methacrylate.

The content of the monomer unit of the alkyl methacrylate (hereinafter, also referred to as the alkyl methacrylate unit) is 30 to 60 parts by mass. The lower limit of the content is preferably 33 parts by mass or more, more preferably 35 parts by mass or more, and further preferably 37 parts by mass or more. The upper limit of the content is preferably 58 parts by mass or less, more preferably 55 parts by mass or less, and further preferably 50 parts by mass or less. When the content of the alkyl methacrylate unit is 30 parts by mass or more, heat resistance and chemical resistance of the acrylic rubber composition and the crosslinked product thereof can be improved. When the content of the alkyl methacrylate unit is 60 parts by mass or less, cold resistance can be improved. The content of the alkyl methacrylate unit in the acrylic rubber is quantitatively determined on the basis of a nuclear magnetic resonance spectrum obtained from the acrylic rubber or the acrylic rubber composition, similarly to the alkyl acrylate unit.

The acrylic rubber of the present embodiment may further contain a crosslinking monomer as the monomer units. The crosslinking monomer refers to a monomer having a functional group that forms a crosslinking site (also called a crosslinking point). The crosslinking monomer is preferably a monomer having a carboxy group. The carboxy group of the crosslinking monomer makes the intermolecular crosslinking of the acrylic rubber possible, and the hardness and the elongation at break of the acrylic rubber composition and the crosslinked product thereof can be adjusted.

Examples of the crosslinking monomer having a carboxy group include acrylic acid, methacrylic acid, crotonic acid, 2-pentenoic acid, maleic acid, fumaric acid, itaconic acid, monoalkyl maleate, monoalkyl fumarate, monocyclohexyl maleate, monocyclohexyl fumarate, and cinnamic acid, but the crosslinking monomer is not limited thereto. The crosslinking monomer may be used singly or in combination of two or more.

From the viewpoint that monomers are easily subjected to a copolymerization reaction, and the heat resistance of the acrylic rubber and the crosslinked product thereof can be further improved, the crosslinking monomer is preferably monoalkyl maleate having an alkyl group with 1 to 8 carbon atoms or monoalkyl fumarate having an alkyl group with 1 to 8 carbon atoms and more preferably monobutyl maleate or monobutyl fumarate.

The content of the monomer unit of the crosslinking monomer (hereinafter, also referred to the crosslinking monomer unit) in the acrylic rubber is preferably 0.1 parts by mass or more, more preferably 0.2 parts by mass or more, and further preferably 0.5 parts by mass or more, with respect to 100 parts by mass of the alkyl acrylate unit. When the content of the crosslinking monomer unit is 0.1 parts by mass or more, a sufficient effect of crosslinking the acrylic rubber is attained, and the strength of the crosslinked product of the acrylic rubber is improved. The content of the crosslinking monomer unit is preferably 5 parts by mass or less, more preferably 4 parts by mass or less, and further preferably 3 parts by mass or less, with respect to 100 parts by mass of the alkyl acrylate unit. When the content of the crosslinking monomer unit is 5 parts by mass or less, the crosslinked product of the acrylic rubber is not cured too much, and the rubber elasticity of this crosslinked product can be stably maintained. For example, when the crosslinking monomer is a crosslinking monomer having a carboxy group, the content of the crosslinking monomer unit can be quantitatively determined by dissolution of the acrylic rubber in toluene and neutralization titration of the solution with potassium hydroxide.

The acrylic rubber may contain ethylene as the monomer units. When the acrylic rubber contains a monomer unit of ethylene (hereinafter, also referred to as the ethylene unit), cold resistance and strength of the crosslinked product of the acrylic rubber are improved. Furthermore, when the acrylic rubber contains the ethylene unit, for example, in the case of using the crosslinked product of the acrylic rubber as a hose member, the appearance of this hose member becomes smooth, and the aesthetic appearance of the hose member is improved.

The content of the ethylene unit is preferably 0.1 parts by mass or more, more preferably 0.2 parts by mass or more, and further preferably 0.5 parts by mass or more, with respect to 100 parts by mass of the alkyl acrylate unit. The content of the ethylene unit is preferably 10 parts by mass or less, more preferably 8 parts by mass or less, and further preferably 5 parts by mass or less, with respect to 100 parts by mass of the alkyl acrylate unit. When the ethylene unit is in the above range, cold resistance and strength of the crosslinked product of the acrylic rubber is even more improved. The content of the ethylene unit in the acrylic rubber can be quantitatively determined on the basis of a nuclear magnetic resonance spectrum obtained from the acrylic rubber or the acrylic rubber composition.

The acrylic rubber may further contain an additional monomer copolymerizable with the alkyl acrylate and the alkyl methacrylate, as the monomer units. Examples of the additional copolymerizable monomer include ethylenically unsaturated compounds other than the above-described monomers. Examples of the ethylenically unsaturated compounds include an alkoxy (meth)acrylate, an alkyl vinyl ketone, a vinyl ether, an allyl ether, a vinyl aromatic compound, a vinyl nitrile, a dialkyl maleate, a dialkyl fumarate, a dialkyl itaconate, a dialkyl citraconate, a dialkyl mesaconate, a dialkyl 2-pentene diacid, and a dialkyl acetylenedicarboxylate. More specific examples of the compound include methoxyethyl acrylate, vinyl acetate, methyl vinyl ketone, vinyl ethyl ether, allyl methyl ether, styrene, α-methyl styrene, chlorostyrene, vinyl toluene, vinylnaphthalene, acrylonitrile, methacrylonitrile, acrylamide, propylene, butadiene, isoprene, pentadiene, vinyl chloride, vinylidene chloride, vinyl fluoride, vinylidene fluoride, vinyl propionate, dimethyl maleate, dimethyl fumarate, dimethyl itaconate, dimethyl citraconate, dimethyl mesaconate, dimethyl 2-pentene diacid, and dimethyl acetylenedicarboxylate.

The acrylic rubber of the present embodiment can be obtained by copolymerization of the above-described monomers by a known method such as emulsion polymerization, suspension polymerization, solution polymerization, or bulk polymerization.

(Acrylic Rubber Composition and Crosslinked Product Thereof)

The acrylic rubber composition of the present embodiment contains the above-described acrylic rubber, a carbon black, a crosslinking agent, and a crosslinking accelerator. Note that, the crosslinking agent and the crosslinking accelerator are also generally referred to as a vulcanizing agent and a vulcanization accelerator, respectively, but in the present specification, the crosslinking agent may be a compound containing sulfur or may be a compound not containing sulfur.

The content of the acrylic rubber in the acrylic rubber composition may be, for example, 50% by mass or more, 55% by mass or more, or 60% by mass or more, and may be 90% by mass or less, based on the total amount of the acrylic rubber composition.

The carbon black is not particularly limited, and examples thereof include an acetylene black, a ketjen black, a thermal black, a channel black, a furnace black, a lamp black, and a graphitized carbon black. In order to further improve mechanical properties and heat resistance, the carbon black preferably contains at least one selected from the group consisting of a furnace black and an acetylene black, and more preferably contains a furnace black.

The content of the carbon black in the acrylic rubber composition is preferably 30 parts by mass or more, more preferably 40 parts by mass or more, and further preferably 45 parts by mass or more, and is preferably 80 parts by mass or less, more preferably 75 parts by mass or less, and further preferably 70 parts by mass or less, with respect to 100 parts by mass of the acrylic rubber. When the content of the carbon black is within the above range, the acrylic rubber composition and the crosslinked product thereof having a good balance between tensile strength and elongation at break and further excellent heat resistance can be obtained.

The crosslinking agent is not particularly limited as long as it is generally used in crosslinking of the acrylic rubber. In a case where the acrylic rubber contains a crosslinking monomer having a carboxy group as the monomer units, the crosslinking agent is preferably a polyamine-based crosslinking agent having two or more amino groups.

Examples of the polyamine-based crosslinking agent include a polyamine compound having two or more amino groups, and a carbonate of the polyamine compound. The polyamine-based crosslinking agent is preferably a diamine-based crosslinking agent having two amino groups. Examples of the diamine-based crosslinking agent include a diamine compound having two amino groups and a carbonate of the diamine compound. The number of carbon atoms in the polyamine compound (diamine compound) may be, for example, 4 or more and 30 or less.

Specific examples of the diamine compound include aromatic diamine compounds such as 4,4′-bis(4-aminophenoxy)biphenyl, 4,4′-diaminodiphenyl sulfide, 1,3-bis(4-aminophenoxy)-2,2-dimethylpropane, 1,3-bis(4-aminophenoxy)benzene, 1,4-bis(4-aminophenoxy)benzene, 1,4-bis(4-aminophenoxy)pentane, 2,2-bis[4-(4-aminophenoxy)phenyl]propane, 2,2-bis[4-(4-aminophenoxy)phenyl]sulfone, 4,4′-diaminodiphenylsulfone, bis(4-3-aminophenoxy)phenylsulfone, 2,2-bis[4-(4-aminophenoxy)phenyl]hexafluoropropane, 3,4′-diaminodiphenyl ether, 4,4′-diaminodiphenyl ether, 4,4′-diaminobenzanilide, and bis[4-(4-aminophenoxy)phenyl]sulfone; and aliphatic diamine compounds such as hexamethylendiamine, hexamethylendiamine carbamate, and N,N′-dicinnamylidene-1,6-hexanediamine. Examples of the polyamine compound having three or more amino groups include aliphatic polyamine compounds such as diethylenetriamine, triethylenetetramine, and tetraethylenepentamine.

The content of the crosslinking agent in the acrylic rubber composition is preferably 0.1 parts by mass or more, more preferably 0.2 parts by mass or more, and further preferably 0.3 parts by mass or more, with respect to 100 parts by mass of the acrylic rubber. The content of the crosslinking agent is preferably 5 parts by mass or less, more preferably 4 parts by mass or less, and further preferably 3 parts by mass or less, with respect to 100 parts by mass of the acrylic rubber. When the content of the crosslinking agent is within the above range, a crosslinking treatment can be suitably performed.

The crosslinking accelerator is not particularly limited as long as it is usually used as a crosslinking accelerator for an acrylic rubber. Examples of the crosslinking accelerator include an amine-based crosslinking accelerator, a guanidine-based crosslinking accelerator, an imidazole-based crosslinking accelerator, a quaternary onium salt-based crosslinking accelerator, a tertiary phosphine-based crosslinking accelerator, an alkali metal salt of a weak acid-based crosslinking accelerator, and a diazabicycloalkene-based crosslinking accelerator. The crosslinking accelerator may be used alone or in combination of two or more thereof.

When the crosslinking agent is a polyamine-based crosslinking agent (preferably a diamine-based crosslinking agent), the crosslinking accelerator is preferably one or more selected from the group consisting of an amine-based crosslinking accelerator and a guanidine-based crosslinking accelerator.

The amine-based crosslinking accelerator is preferably a monoamine-based crosslinking accelerator having one amino group. Examples of the monoamine crosslinking accelerator include an aliphatic secondary active monoamine compound and an aliphatic tertiary monoamine compound.

Examples of the aliphatic secondary monoamine compound include dimethylamine, diethylamine, di-n-propylamine, diallylamine, diisopropylamine, di-n-butylamine, di-t-butylamine, di-sec-butylamine, dihexylamine, diheptylamine, dioctylamine, dinonylamine, didecylamine, diundecylamine, didodecylamine, ditridecylamine, ditetradecylamine, dipentadecylamine, dicetylamine, di-2-ethylhexylamine, dioctadecylamine, di-cis-9-octadecenylamine, and dinonadecylamine.

Examples of the aliphatic tertiary monoamine compound include trimethylamine, triethylamine, tri-n-propylamine, triallylamine, triisopropylamine, tri-n-butylamine, tri-t-butylamine, tri-sec-butylamine, tripentylamine, trihexylamine, triheptylamine, trioctylamine, trinonylamine, tridecylamine, triundecylamine, tridodecylamine, tridecylamine, tritetradecylamine, tripentadecylamine, tricetylamine, tri-2-ethylhexylamine, trioctadecylamine, tri-cis-9-octadecenylamine, trinonadecylamine, N,N-dimethyldecylamine, N,N-dimethyldodecylamine, N,N-dimethyltetradecylamine, N,N-dimethylcetylamine, N,N-dimethyloctadecylamine, N,N-dimethylbehenylamine, N-methyldidecylamine, N-methyldidodecylamine, N-methylditetradecylamine, N-methyldicetylamine, N-methyldioctadecylamine, N-methyldibehenylamine, and dimethylcyclohexylamine.

Examples of the guanidine-based crosslinking accelerator include 1,3-di-o-tolylguanidine and 1,3-diphenylguanidine.

Examples of the imidazole-based crosslinking accelerator include 2-methylimidazole and 2-phenylimidazole.

The quaternary onium salt-based crosslinking accelerator is not particularly limited, and examples thereof include ammonium salts such as tetra-n-butylammonium chloride, trimethylphenylammonium chloride, trimethylstearylammonium chloride, trimethyllaurylammonium chloride, trimethylcetylammonium chloride, dimethyldistearylammonium chloride, tributylbenzylammonium chloride, tetra-n-butylammonium bromide, methyltriphenylammonium bromide, ethyltriphenylammonium bromide, trimethylphenylammonium bromide, trimethylbenzylammonium bromide, trimethylstearylammonium bromide, and tetrabutylammonium thiocyanate, and phosphonium salts such as tetra-n-butylphosphonium chloride, tetra-n-butylphosphonium bromide, methyltriphenylphosphonium bromide, ethyltriphenylphosphonium bromide, butyltriphenylphosphonium bromide, hexyltriphenylphosphonium bromide, benzyltriphenylphosphonium bromide, tetraphenylphosphonium chloride, tetraphenylphosphonium bromide, 4-butoxybenzyltriphenylphosphonium bromide, allyltributylphosphonium chloride, 2-propynyltriphenylphosphonium bromide, and methoxypropyltributylphosphonium chloride.

Examples of the tertiary phosphine-based crosslinking accelerator include triphenylphosphine and tri-p-tolylphosphine.

Examples of the alkali metal salt of a weak acid-based crosslinking accelerator include inorganic weak acid salts such as phosphates and carbonates of sodium and potassium, and organic weak acid salts such as stearates and laurates of sodium and potassium.

Examples of the diazabicycloalkene-based crosslinking accelerator include 1,8-diazabicyclo[5.4.0]undecene-7 (DBU), 1,5-diazabicyclo[4.3.0]nonene-5 (DBN), and 1,4-diazabicyclo[2.2.2]octane (DABCO). These diazabicycloalkene compounds may form salts, for example, with hydrochloric acid, sulfuric acid, carboxylic acid, sulfonic acid, phenol, and the like. Examples of the carboxylic acid include octylic acid, oleic acid, formic acid, orthophthalic acid, and adipic acid. Examples of the sulfonic acid include benzenesulfonic acid, toluenesulfonic acid, dodecylbenzenesulfonic acid, and naphthalene sulfonic acid.

The content of the crosslinking accelerator in the acrylic rubber composition is preferably 0.1 parts by mass or more, more preferably 0.2 parts by mass or more, and further preferably 0.3 parts by mass or more, with respect to 100 parts by mass of the acrylic rubber. Furthermore, the content of the crosslinking accelerator is preferably 5 parts by mass or less, more preferably 4 parts by mass or less, and further preferably 3 parts by mass or less, with respect to 100 parts by mass of the acrylic rubber. When the content of the crosslinking accelerator is within the above range, a crosslinking treatment can be suitably performed.

The acrylic rubber composition may contain additional additives such as a filler (a reinforcing agent), a plasticizer, a lubricant, an anti-aging agent, a stabilizer, and a silane coupling agent, depending on intended practical use.

The filler (the reinforcing agent) may be fillers (reinforcing agents) used in general acrylic rubbers, and examples thereof include fillers (reinforcing agents) such as silica, clay, talc, calcium carbonate, antimony trioxide, and aluminum hydroxide.

Examples of the lubricant include a liquid paraffin, stearic acid, stearylamine, a fatty acid zinc, a fatty acid ester, and an organosilicone. The content of the lubricant may be 0.1 parts by mass or more, 0.5 parts by mass or more, or 1 part by mass or more, and may be 10 parts by mass or less, 5 parts by mass or less, or 3 parts by mass or less, with respect to 100 parts by mass of the acrylic rubber.

Examples of the anti-aging agent include an aromatic amine compound and a phenol compound. The content of the anti-aging agent may be 0.1 parts by mass or more, 0.3 parts by mass or more, or 0.5 parts by mass or more, and may be 10 parts by mass or less, 5 parts by mass or more, or 3 parts by mass or less, with respect to 100 parts by mass of the acrylic rubber.

The total content of the additional additives in the acrylic rubber composition may be 0.1 parts by mass or more, 0.2 parts by mass or more, or 1 part by mass or more, and may be 90 parts by mass or less, 80 parts by mass or less, 50 parts by mass or less, 20 parts by mass or less, 10 parts by mass or less, or 5 parts by mass or less, with respect to 100 parts by mass of the acrylic rubber.

The crosslinked product of the acrylic rubber composition can be obtained by kneading this acrylic rubber composition at a temperature equal to or lower than a crosslinking temperature and then heating at a predetermined crosslinking temperature. When the crosslinked product of the acrylic rubber composition is molded into a desired shape, the acrylic rubber composition can be molded into the desired shape and then crosslinked to obtain a crosslinked product, or can also be crosslinked to obtain a crosslinked product and then the crosslinked product can be molded into the desired shape.

The heating conditions at the time of crosslinking can be appropriately set depending on the blending of the acrylic rubber composition or the type of the crosslinking agent, and may be, for example, 100 to 200° C. for 1 to 10 hours. As a heating method, methods used in crosslinking of rubber such as hot press heating, steam heating, and oven heating can be used.

As an apparatus of kneading, molding, and crosslinking the acrylic rubber composition and an apparatus of kneading and molding the crosslinked product of the acrylic rubber composition, apparatuses used for general acrylic rubber compositions can be used. As the kneading apparatus, a roll, a kneader, a Banbury mixer, an internal mixer, and a twin-screw extruder, and the like can be used.

The crosslinked product of the present embodiment is used as an industrial member, and is suitably used, particularly, as a hose member such as a rubber hose; a sealing member such as a gasket or a packing; a vibration-proof rubber member; and the like. That is, another embodiment of the present invention is a hose member, a sealing member, or a vibration-proof rubber member containing the above-described crosslinked product. These members may be formed from only the crosslinked product of the acrylic rubber composition, and may include this crosslinked product and other parts.

Examples of the hose member include transmission oil cooler hoses, engine oil cooler hoses, air duct hoses, turbo intercooler hoses, hot air hoses, radiator hoses, power steering hoses, fuel-line hoses, and drain-line hoses of automobiles, construction machines, hydraulic equipment, and the like. The hose member may have reinforcing filaments or wires on the intermediate layer or outermost layer of the hose.

Examples of the sealing member include engine head cover gaskets, oil pan gaskets, oil seals, lip seal packings, O-rings, transmission seal gaskets, crank shafts, cam shaft seal gaskets, valve stems, power steering seals, belt cover seals, constant-velocity-joint boot materials, and rack-and-pinion boot materials.

Examples of the vibration-proof rubber member include damper pulleys, center support cushions, and suspension bushings.

### Examples

Hereinafter, the present invention will be more specifically described based on Examples, however, the present invention is not limited by these Examples.

Six types of acrylic rubbers A to F were produced in the conditions shown below.

<Acrylic Rubber A>

In a pressure-resistant reaction container having an internal volume of 40 liters, 17 kg of 4% by mass aqueous solution of partially saponified polyvinyl alcohol and 56 g of sodium formaldehyde sulfoxylate were charged, and the whole was thoroughly mixed with a stirrer in advance, thereby preparing a homogeneous suspension. The air in the upper part of the container was replaced with nitrogen, then 0.9 kg of ethylene was injected under pressure into the upper part of the container, and the pressure was adjusted at 3.5 MPa. Under stirring, the temperature in the container was maintained at 55° C., and 5.2 kg of ethyl acrylate, 2.9 kg of n-butyl acrylate, 3.1 kg of n-butyl methacrylate, 0.22 kg of monobutyl fumarate, and a 0.5% by mass aqueous solution of t-butyl hydroperoxide were separately injected under pressure from an inlet to start polymerization. The temperature in the container during the reaction was maintained at 55° C., and the reaction was performed until the polymerization conversion ratio reached 95%. To the resulting polymerization liquid, 20 kg of 0.3% by mass aqueous solution of sodium borate was added to solidify the polymer, and the polymer was dehydrated and dried to obtain an acrylic rubber A.

This acrylic rubber A had a copolymer composition of 65 parts by mass of the ethyl acrylate unit, 35 parts by mass of the n-butyl acrylate unit, 41 parts by mass of the n-butyl methacrylate unit, 2.2 parts by mass of the ethylene unit, and 2.2 parts by mass of the monobutyl fumarate unit. These monomer units were quantitatively determined using a nuclear magnetic resonance spectrum method (the same applies hereinafter).

<Acrylic Rubber B>

The same method as in the acrylic rubber A was performed to obtain an acrylic rubber B, except that n-butyl acrylate and monobutyl fumarate were not used, and monomers to be used were changed to 7.6 kg of ethyl acrylate, 3.6 kg of n-butyl methacrylate, 0.9 kg of ethylene, and 0.28 kg of monobutyl maleate.

This acrylic rubber B had a copolymer composition of 100 parts by mass of the ethyl acrylate unit, 45 parts by mass of the n-butyl methacrylate unit, 2.4 parts by mass of the ethylene unit, and 2.2 parts by mass of the monobutyl maleate unit.

<Acrylic Rubber C>

The same method as in the acrylic rubber A was performed to obtain an acrylic rubber C, except that n-butyl acrylate and monobutyl fumarate were not used, and monomers to be used were changed to 8.3 kg of ethyl acrylate, 2.9 kg of n-butyl methacrylate, 0.9 kg of ethylene, and 0.28 kg of monobutyl maleate.

This acrylic rubber C had a copolymer composition of 100 parts by mass of the ethyl acrylate unit, 35 parts by mass of the n-butyl methacrylate unit, 2.4 parts by mass of the ethylene unit, and 2.2 parts by mass of the monobutyl maleate unit.

<Acrylic Rubber D>

The same method as in the acrylic rubber A was performed to obtain an acrylic rubber D, except that n-butyl acrylate and monobutyl fumarate were not used, and monomers to be used were changed to 8.3 kg of ethyl acrylate, 2.9 kg of n-butyl methacrylate, 0.9 kg of ethylene, and 0.28 kg of monobutyl maleate.

This acrylic rubber D had a copolymer composition of 100 parts by mass of the ethyl acrylate unit, 55 parts by mass of the n-butyl methacrylate unit, 2.4 parts by mass of the ethylene unit, and 2.2 parts by mass of the monobutyl maleate unit.

<Acrylic Rubber E>

The same method as in the acrylic rubber A was performed to obtain an acrylic rubber E, except that n-butyl methacrylate and monobutyl fumarate were not used, and monomers to be used were changed to 7.8 kg of ethyl acrylate, 3.4 kg of n-butyl acrylate, 0.9 kg of ethylene, and 0.28 kg of monobutyl maleate.

This acrylic rubber E had a copolymer composition of 73 parts by mass of the ethyl acrylate unit, 27 parts by mass of the n-butyl acrylate unit, 1 part by mass of the ethylene unit, and 1.3 parts by mass of the monobutyl maleate unit.

<Acrylic Rubber F>

The same method as in the acrylic rubber A was performed to obtain an acrylic rubber F, except that n-butyl methacrylate, monobutyl fumarate and ethylene were not used, and monomers to be used were changed to 7.3 kg of ethyl acrylate, 3.8 kg of n-butyl acrylate and 0.28 kg of monobutyl maleate.

This acrylic rubber F had a copolymer composition of 66 parts by mass of the ethyl acrylate unit, 34 parts by mass of the n-butyl acrylate unit, and 1 part by mass of the monobutyl maleate unit.

The monomer compositions of the acrylic rubbers A to F are collectively shown in Table 1 below.

TABLE 1

| Acrylic rubber | | | A | B | C | D | E | F |
|---|---|---|---|---|---|---|---|---|
| Monomer | Ethyl | Parts | 65 | 100 | 100 | 100 | 73 | 66 |
| composition | acrylate | by | | | | | | |
| | n-Butyl | mass | 35 | — | — | — | 27 | 34 |
| | acrylate | | | | | | | |
| | n-Butyl | | 41 | 45 | 35 | 55 | — | — |
| | methacrylate | | | | | | | |
| | Ethylene | | 2.2 | 2.4 | 2.4 | 2.4 | 1 | — |
| | Monobutyl | | — | 2.2 | 2.2 | 2.2 | 1.3 | 1 |
| | maleate | | | | | | | |
| | Monobutyl | | 2.2 | — | — | — | — | — |
| | fumarate | | | | | | | |

The above-described acrylic rubbers A to F and other materials were kneaded using an 8-inch open roll at blending in Table 2, thereby obtaining acrylic rubber compositions of Examples 1 to 4 and Comparative Examples 1 to 2. These acrylic rubber compositions (non-crosslinked) were molded into a thickness of 2 mm and subjected to a heating treatment with a hot press at 170° C.×20 minutes to obtain primary crosslinked products, and then the primary crosslinked products were subjected to a heating treatment with hot air (geer oven) at 170° C.×4 hours, thereby obtaining crosslinked products of the acrylic rubber compositions.

Details of the components other than the acrylic rubber shown in Table 2 are as follows.
Carbon black: Furnace Black N550 (SEAST SO manufactured by TOKAI CARBON CO., LTD.)
Crosslinking agent: Hexamethylendiamine carbamate (Diak #1 manufactured by DuPont)
Crosslinking accelerator: Synthetic mixtures of an active amine and a retarder (XLA-60 manufactured by LANXESS)
Lubricant a: Stearic acid (manufactured by NOF CORPORATION)
Lubricant b: Stearylamine (FARMIN 80S manufactured by Kao Corporation)
Anti-aging agent: 4,4′-Bis(α,α-dimethylbenzyl) diphenylamine (NAUGARD 445 manufactured by Addivant USA LLC)

Heat resistance and chemical resistance of the obtained crosslinked products of the acrylic rubber compositions were evaluated under the following conditions. The results are shown in Table 2.

(Heat Resistance Test)

The crosslinked product of the acrylic rubber composition was subjected to a thermal treatment at a test temperature of 190° C. for a test time of 504 hours according to JIS K6257:2017. The tensile strength at break Tb and the elongation at break Eb of each of the crosslinked products before and after the heat treatment were measured in accordance with JIS K6251:2017 using a dumbbell-shaped No. 3, and the rate of change in tensile strength at break ΔTb and the rate of change in elongation at break ΔEb before and after the heat treatment were determined in accordance with the following equations.

ΔTb (%)=(Tb after heat treatment−Tb before heat treatment)/Tb before heat treatment×100

ΔEb (%)=(Eb after heat treatment−Eb before heat treatment)/Eb before heat treatment×100

The closer ΔTb and ΔEb are to 0 (the smaller the absolute values are), the smaller the change before and after heat treatment is and the higher the heat resistance is.

(Chemical Resistance Test)

Chemical resistance was evaluated using the crosslinked product of each acrylic rubber composition in accordance with JIS K6258:2016. Specifically, the obtained crosslinked product was immersed in each of a nitric acid aqueous solution, an acetic acid aqueous solution, and a sodium hydroxide aqueous solution prepared to have a concentration of 10% by mass in an oven at 70° C. for 144 hours. The volume V and weight W of each of the crosslinked products before and after the immersion were measured, and the volume change rate ΔV and weight change rate ΔW before and after the immersion were determined according to the following equations.

ΔV (%)=(V after immersion−V before immersion)/V before immersion×100

ΔW (%)=(W after immersion−W before immersion)/W before immersion×100

The closer ΔV and ΔW are to 0 (the smaller the absolute values are), the smaller the change before and after immersion is and the higher the chemical resistance is.

TABLE 2

| | | | Example | | | | Comparative Example | |
|---|---|---|---|---|---|---|---|---|
| | | | 1 | 2 | 3 | 4 | 1 | 2 |
| Type of acrylic rubber | | | A | B | C | D | E | F |
| Blending | Acrylic rubber | | 100 | 100 | 100 | 100 | 100 | 100 |
| (parts by | Carbon black | | 45 | 50 | 50 | 50 | 50 | 50 |
| mass) | Crosslinking agent | | 0.4 | 0.4 | 0.4 | 0.4 | 0.4 | 0.4 |
| | Crosslinking | | 0.8 | 0.8 | 0.8 | 0.8 | 0.8 | 0.8 |
| | accelerator | | | | | | | |
| | Lubricant a | | 1 | 1 | 1 | 1 | 1 | 1 |
| | Lubricant b | | 0.5 | 0.5 | 0.5 | 0.5 | 0.5 | 0.5 |
| | Anti-aging agent | | 1 | 1 | 1 | 1 | 1 | 1 |
| Heat | ΔTb (%) | | −28 | −31 | −33 | −29 | −38 | -33 |
| resistance | ΔEb (%) | | −12 | −12 | −18 | −9 | −25 | -28 |
| Chemical | Nitric | ΔV (%) | +8 | +9 | +9 | +7 | +12 | +15 |
| resistance | acid | ΔW (%) | +7 | +7 | +8 | +7 | +10 | +13 |
| | Acetic | ΔV (%) | +9 | +10 | +11 | +8 | +12 | +16 |
| | acid | ΔW (%) | +7 | +7 | +8 | +7 | +10 | +13 |
| | Sodium | ΔV (%) | +78 | +80 | +91 | +72 | +161 | +245 |
| | hydroxide | ΔW (%) | +69 | +70 | +79 | +58 | +143 | +220 |

What is claimed is:

1. An acrylic rubber composition comprising:
an acrylic rubber comprising 100 parts by mass of an alkyl acrylate and 30 to 60 parts by mass of an alkyl methacrylate, as monomer units;
a carbon black;
a crosslinking agent; and
a crosslinking accelerator.

2. The acrylic rubber composition according to claim 1, wherein the alkyl methacrylate is n-butyl methacrylate.

3. The acrylic rubber composition according to claim 1, wherein the alkyl acrylate is one or more selected from the group consisting of ethyl acrylate and n-butyl acrylate.

4. The acrylic rubber composition according to claim 1, wherein the acrylic rubber further comprises a crosslinking monomer having a carboxy group as the monomer units.

5. The acrylic rubber composition according to claim 1, wherein the acrylic rubber further comprises ethylene as the monomer units.

6. The acrylic rubber composition according to claim 1, wherein
the crosslinking agent is a diamine-based crosslinking agent, and
the crosslinking accelerator is one or more selected from the group consisting of an amine-based crosslinking accelerator and a guanidine-based crosslinking accelerator.

7. A crosslinked product of the acrylic rubber composition according to claim 1.

8. A hose member comprising the crosslinked product according to claim 7.

9. A sealing member comprising the crosslinked product according to claim 7.

10. A vibration-proof rubber member comprising the crosslinked product according to claim 7.
